(19) United States
(12) Patent Application Publication
(10) Pub. No.: US 2006/0115281 A1
(43) Pub. Date: Jun. 1, 2006

(54) Image forming device, customer replaceable unit host device, and controlling methods thereof

(76) Inventors: Haeng-nan Kim, Suwon-si (KR); Bong-jik Yang, Yongin-si (KR)

Correspondence Address: STANZIONE & KIM, LLP, 919 18TH STREET, N.W., SUITE 440, WASHINGTON, DC, 20006, US

(21) Appl. No.: 11/283,814

(22) Filed: Nov. 22, 2005

(30) Foreign Application Priority Data
Nov. 29, 2004 (KR) 2004-98477

(51) Int. Cl. G03G 15/00

(52) U.S. Cl. 399/8

(57) ABSTRACT

An image forming device, a customer replaceable unit host device in communication with the image forming device, and controlling methods thereof. The image forming device includes a recording material storage medium, a customer replaceable unit memory (CRUM) associated with the recording material storage medium to store usage information for replaceable units installed in the image forming device, and a first controller to collect the replaceable unit usage information, to control the replaceable unit usage information to be stored in the CRUM, and to transmit the replaceable unit usage information to the customer replaceable unit host device. In this manner, a plurality of image forming devices can be collectively managed in an efficient manner.

### CROSS-REFERENCE TO RELATED APPLICATIONS

This application claims the benefit under 35 U.S.C. § 119 of Korean Patent Application No. 2004-98477, filed on Nov. 29, 2004, the entire content of which is incorporated herein by reference.

### BACKGROUND OF THE INVENTION

1. Field of the Invention

The present general inventive concept relates in general to an image forming device, a customer replaceable unit host device, and controlling methods thereof. More specifically, the present general inventive concept relates to an image forming device provided with a customer replaceable unit memory (CRUM) associated with a recording material storage medium, a customer replaceable unit host device in communication with the image forming device, and controlling methods thereof.

2. Description of the Related Art

Image forming devices form (i.e., print) images corresponding to an original input image data on recording media, such as printing papers. Typical examples of the image forming devices are printers, copiers, fax machines, etc.

An image forming device uses toner as a recording material, and toner cartridges and ink cartridges are generally used as a storage medium for the recording material. According to a recent trend, a recording material management memory for managing the recording material is provided at a designated position of the recording material storage medium. The recording material management memory stores data for management of the recording material. For example, the stored data is a remaining quantity of the recording material.

Typically, more than one image forming device is provided in an office in order to perform a large number of print jobs.

Each of the image forming devices has a number of replaceable parts and/or expendable commodities (“replaceable units”). In other words, after lifespans of the replaceable parts and/or expendable commodities have expired, a user must replace them. The image forming devices typically notify or display a message that the lifespan of the replaceable unit has expired. Unfortunately however, this method often puts a device manager at an inconvenience because the device manager is required to separately manage the replaceable units of every image forming device. In other words, the device manager does not purchase any replacements for the expired replaceable units unless the image forming devices display a notification message regarding the expired lifespan of a certain replaceable unit. This requires an excess amount of time and energy, and is a burden to the device manager.

Although the device manager could purchase some replacements for replaceable units having lifespans that are expected to expire in the near future, this may lead the device manager to spend extra money on replacements for replaceable units that do not yet need to be replaced.

### SUMMARY OF THE INVENTION

The present general inventive concept provides an image forming device, a customer replaceable unit host device in communication with the image forming device, and controlling methods thereof, wherein a recording material storage medium installed in the image forming device is associated with a customer replaceable unit memory to collect usage information of all replaceable units, and the customer replaceable unit host device utilizes the usage information for more effective management of the replaceable units.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming device in communication with a customer replaceable unit host device, including: a recording material storage medium, a customer replaceable unit memory (CRUM) associated with the recording material storage medium to store usage information for replaceable units installed in the image forming device, and a first controller to collect the replaceable unit usage information, to control the replaceable unit usage information to be stored in the CRUM, and to transmit the replaceable unit usage information to the customer replaceable unit host device.

The image forming device may further include: an input unit to receive at least one of a transmission command to request an immediate transmission of the replaceable unit usage information from the CRUM to the customer replaceable unit host device and a set command to request a periodic transmission of the replaceable unit usage information from the CRUM to the customer replaceable unit host device at predetermined time intervals.

The CRUM further stores replacement threshold information of each replaceable unit, and the first controller compares the replacement threshold information with the corresponding replaceable unit usage information and if the replaceable unit usage is greater than the corresponding replacement threshold the first controller controls the replaceable unit usage information to be transmitted to the customer replaceable unit host device.

When the image forming device is initially turned on, the first controller controls the replaceable unit usage information in the CRUM to be transmitted to the customer replaceable unit host device.

The foregoing and/or other aspects of the present general inventive concept are also achieved by providing a controlling method of an image forming device in communication with a customer replaceable unit host device, the method including: collecting usage information of replaceable units installed in the image forming device, storing the replaceable unit usage information in a customer replaceable unit memory (CRUM) associated with a recording material storage medium of the image forming device, and transmitting the replaceable unit usage information in the CRUM to the customer replaceable unit host device.

The transmission of the replaceable unit usage information in the CRUM to the customer replaceable host device may include transmitting the replaceable unit usage information immediately to the customer replaceable unit host device if a transmission command requesting an immediate transmission of the replaceable unit usage information to the customer replaceable unit host device is input.

The transmission of the replaceable unit usage information in the CRUM to the customer replaceable host device may include transmitting the replaceable unit usage information to the customer replaceable unit host device at predetermined time intervals if a set command requesting a periodic transmission of the replaceable unit usage information to the customer replaceable unit host device at the predetermined time intervals is input.

The transmission of the replaceable unit usage information in the CRUM to the customer replaceable host device may include comparing replacement threshold information of each replaceable unit with the corresponding replaceable unit usage information stored in the CRUM, and if a result of the comparison indicates that the replaceable unit usage is greater than the corresponding replacement threshold, transmitting the replaceable unit usage information to the customer replaceable unit host device.

The transmission of the replaceable unit usage information in the CRUM to the customer replaceable host device may include transmitting the stored replaceable unit usage information to the customer replaceable unit host device when the image forming device is initially turned on.

The foregoing and/or other aspects of the present general inventive concept are also achieved by providing a customer replaceable unit host device in communication with at least one image forming device, including a replacement management unit to provide a customer replaceable unit table based on usage information of replaceable units installed in the at least one image forming device, the replaceable unit usage information being obtained from a customer replaceable unit memory (CRUM) associated with a recording material storage medium of each of the at least one image forming device, and a second controller to search the customer replaceable unit table for one or more target replacements associated with one or more of the replaceable units and to provide information about the one or more target replacements as a replacement request if the one or more target replacements exist.

The customer replaceable unit table may include at least one of replacement names, replacement schedules prepared based on the replaceable unit usage information, and information about suppliers of the respective replaceable units.

The customer replaceable unit host device may further include a second input unit to receive a display command to display the customer replaceable unit table, and a second display unit to display the customer replaceable unit table under the control of the second controller, in response to the received display command.

The host device may further include a display unit to display a replacement request notification information containing information about the one or more target replacements that is generated based on the customer replaceable unit table, under the control of the second controller.

The host device may further include a message generator to generate at least one of a purchase order message containing information about the one or more target replacements being provided to a replacement sales server and a replacement request message containing information about the one or more target replacements being provided to a replacement manager.

The replacement management unit may generate usage statistical information for predetermined periods based on the replaceable unit usage information, and may record the usage statistical information in the customer replaceable unit table.

The foregoing and/or other aspects of the present general inventive concept are also achieved by providing a controlling method of a customer replaceable unit host device in communication with at least one image forming device, the method including: receiving usage information about replaceable units installed in the at least one image forming device from a customer replaceable unit memory (CRUM) associated with a recording material storage medium of each of the at least one image forming device, preparing a customer replaceable unit table based on the received replaceable unit usage information, searching the customer replaceable unit table for one or more target replacements associated with one or more of the replaceable units, and if the one or more target replacements exist, providing information about the one or more target replacements as a replacement request.

The providing of the information about the one or more target replacements may include displaying a replacement request notification information containing the information about the one or more target replacements.

The providing of the information about the one or more target replacements may include generating a purchase order message containing the information about the one or more target replacements based on the customer replaceable unit table, and transmitting the purchase order message to a replacement sales server.

The providing of the information about the one or more target replacements may include generating a replacement request message containing the information about the one or more target replacements based on the customer replaceable unit table, and transmitting the replacement request message to a replacement manager.

The controlling method may further include generating usage statistical information for predetermined periods based on the replaceable unit usage information, and recording the usage statistical information in the customer replaceable unit table.

The foregoing and/or other aspects of the present general inventive concept are also achieved by providing a replacement management device in communication with a plurality of image forming apparatuses, the device comprising an interface to receive usage information about replaceable units installed in each of the plurality of image forming apparatuses, a replacement monitor unit to monitor the received usage information and to perform a predetermined operation when the received usage information indicates that one or more of the replaceable units should be replaced.

The foregoing and/or other aspects of the present general inventive concept are also achieved by providing an image forming apparatus in communication with a replacement management device, the apparatus comprising a plurality of replaceable units installed therein, and a replaceable unit memory to store usage information about the plurality of replaceable units and specification information about the plurality of replaceable units.

The foregoing and/or other aspects of the present general inventive concept are also achieved by providing a local printer network, comprising a plurality of printers each having at least one replaceable unit installed therein, and a replacement device to monitor usage of the at least one replaceable unit installed in each of the plurality of printers and to indicate when any of the replaceable units should be replaced.

The foregoing and/or other aspects of the present general inventive concept are also achieved by providing a replaceable unit management system usable with a plurality of image forming apparatuses, the system comprising a management unit including a memory to store a replaceable unit table including usage information about a plurality of replaceable units installed in the plurality of image forming apparatuses and a controller to receive updated usage information from the plurality of image forming apparatuses such that the replaceable units are replaced at appropriate times.

The foregoing and/or other aspects of the present general inventive concept are also achieved by providing a method of managing a plurality of image forming apparatus with a replacement management device in communication with the plurality of image forming apparatuses, the method comprising receiving usage information about replaceable units installed in each of the plurality of image forming apparatuses, and monitoring the received usage information and performing a predetermined operation when the received usage information indicates that one or more of the replaceable units should be replaced.

The foregoing and/or other aspects of the present general inventive concept are also achieved by providing a method of managing a plurality of replaceable units installed in an image forming apparatus by communicating with a replacement management device, the method comprising storing and updating usage information about the plurality of replaceable units and specification information about the plurality of replaceable units.

The foregoing and/or other aspects of the present general inventive concept are also achieved by providing a computer readable medium to control a customer replaceable unit host device in communication with at least one image forming device, the medium comprising a first executable code to receive usage information about replaceable units installed in the at least one image forming device from a customer replaceable unit memory (CRUM) associated with a recording material storage medium of each of the at least one image forming device, a second executable code to prepare a customer replaceable unit table based on the received replaceable usage information, a third executable code to search the customer replaceable unit table for one or more target replacements associated with one or more of the replaceable units, and a fourth executable code to provide information about the one or more target replacements as a replacement request, if the one or more target replacements exist.

Accordingly, the present general inventive concept facilitates the management of image forming devices such that a large number of image forming devices can be collectively managed in an efficient manner.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic block diagram illustrating a customer replaceable unit host device according to an embodiment of the present general inventive concept;

FIG. 2 is a schematic block diagram illustrating a printer and a customer replaceable unit host device according to an embodiment of the present general inventive concept;

FIG. 3 illustrates a customer replaceable unit table according to an embodiment of the present general inventive concept;

FIG. 4 is a flow chart illustrating a controlling method of a printer according to an embodiment of the present general inventive concept; and

FIG. 5 is a flow chart illustrating a controlling method of a customer replaceable unit host device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Throughout the description, a printer is used to represent an image forming device of the present general inventive concept, however, it should be understood that the scope of the present general inventive concept is not intended to be limited thereto. Other types of image forming devices may also be used with the present general inventive concept.

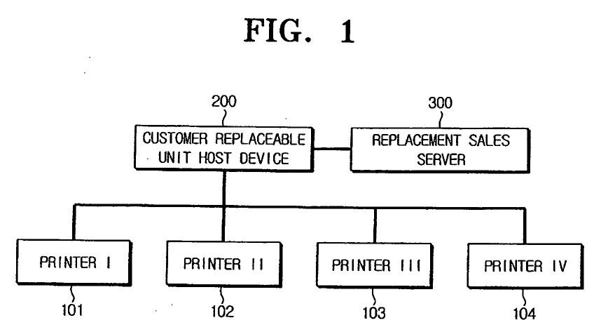

FIG. 1 is a schematic block diagram illustrating a customer replaceable unit host device according to an embodiment of the present general inventive concept.

Referring to FIG. 1, a plurality of printers 101, 102, 103, and 104 communicate with a customer replaceable unit host device 200. The plurality of printers 101, 102, 103, and 104 may communicate through a wired connection or may communicate through a wireless connection. Although FIG. 1 only illustrates four printers, it should be understood that a larger or smaller number of printers can also be used. Usage information of replaceable units disposed in the printer(s) 101, 102, 103, and 104 may be provided to the customer replaceable unit host device 200 at predetermined time intervals. The customer replaceable unit host device 200 then generates a customer replaceable unit table based on the transmitted replaceable unit usage information, and searches for a replaceable unit that needs to be replaced (‘a target replacement’) in each printer 101, 102, 103, and 104 at the predetermined time intervals. If there is a target replacement (i.e., a certain one or more replaceable units that should be replaced), the customer replaceable unit host device 200 notifies a replacement seller. Here, the target replacement can refer to a replaceable part (in one of the printers 101, 102, 103, and 104) or an expendable commodity that is completely or partially exhausted and thus needs replacing.

The customer replaceable unit host device 200 may send a purchase order to a customer replaceable unit sales server 300 to inform the replacement seller of the search result.

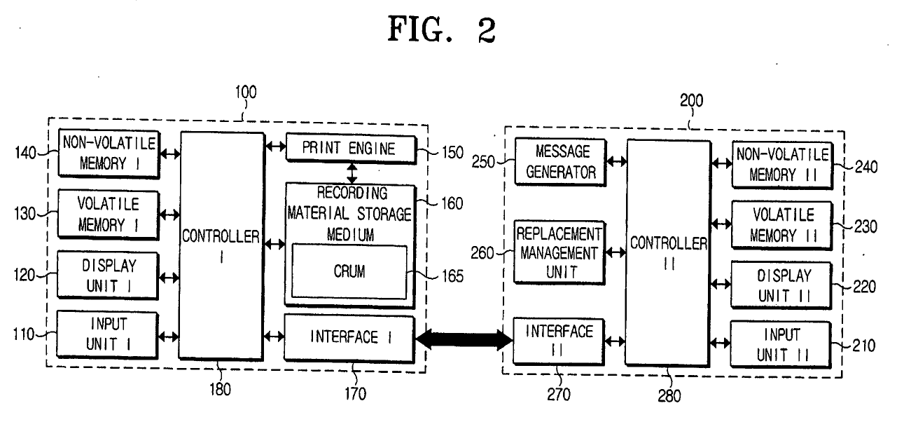

FIG. 2 is a schematic block diagram illustrating a printer 100 and the customer replaceable unit host device 200 according to an embodiment of the present general inventive concept. The printer 100 of FIG. 2 may be one of the printers 101, 102, 103, and 104 illustrated in FIG. 1.

Referring to FIGS. 1 and 2, the printer 100 includes a first input unit 110, a first display unit 120, a first volatile memory 130, a first non-volatile memory 140, a print engine 150, a recording material storage medium 160, a first interface 170, and a first controller 180.

The first input unit 110 includes at least one operation button, so that a user can input any desired command. A user command signal input through the first input unit 110 is provided to the first controller 180, and the first controller 180 controls the printer 100, in response to the user command signal.

An IP address of the customer replaceable unit host device 200 may be input through the first input unit 110. Accordingly, a communication network to transmit the replaceable unit usage information is established between the printer 100 and the customer replaceable unit host device 200.

A transmission command to request that the printer 100 transmit the replaceable unit usage information in the customer replaceable unit memory (CRUM) 165 to the customer replaceable unit host device 200 can be input through the first input unit 110. If the transmission command is input, the first controller 180 reads the replaceable unit usage information from the CRUM 165, and the read replaceable unit usage information is transmitted to the customer replaceable unit host device 200 through the first interface 170 by the first controller 180.

In addition, a set command to request that the printer 100 transmit the replaceable unit usage information in the CRUM 165 to the customer replaceable unit host device 200 at the predetermined time intervals can also be input through the first input unit 110. If the set command is input, the first controller 180 reads the replaceable unit usage information in the CRUM 165 at the predetermined time intervals, and the read replaceable unit usage information is transmitted to the customer replaceable unit host device 200 through the first interface 170 by the first controller 180.

The first display unit 120 displays all types of notification messages intended for the user, in response to a user command or according to the control of the first controller 180.

The first volatile memory 130 temporarily stores data that is produced during operation of the printer 100.

The first non-volatile memory 140 stores a first control program to control overall operation of the printer 100.

The print engine 150 executes a printing operation to print a document, under the control of the first controller 180. That is, the print engine 150 executes the printing operation using the recording material stored in the recording material storage medium 160.

The recording material storage medium 160 stores the recording material that is used to print the document on a printing paper. For example, a toner may be used as the recording material. Additionally, the recording material storage medium 160 may be a toner cartridge.

When the printer 100 is a black and white (i.e., non-color) printer, the printer 100 only uses a one-color recording material such that a single recording material storage medium 160 is sufficient for the printer 100.

When the printer 100 is a color printer, the printer 100 can also use a single recording material storage medium 160. However, in this case, the recording material storage medium 160 may be divided into a plurality of partitioned spaces to store recording materials having different colors. On the other hand, if the printer 100 uses a plurality of recording material storage mediums, the plurality of recording material storage mediums store corresponding different colors of recording materials.

According to the present embodiment, the customer replaceable unit memory (CRUM) 165 is provided at a designated position of the recording material storage medium 160.

The CRUM 165 stores not only information about a residual quantity of the recording material, but also may store a number of printed pages, a printer model name, a printer serial number, a model name of the recording material storage medium 160, a product serial number of the recording material storage medium 160, information about customer replaceable units applied to the printer 100, control programs for the customer replaceable units, a position of a developer provided to the printer 100, a usage frequency of the developer, and developer model information.

In particular, the CRUM 165 may store the replaceable unit usage information that is collected by the first controller 180 at the predetermined time intervals. Additionally, the CRUM 165 stores a replacement threshold information for each replaceable unit. Here, the replacement threshold information indicates a threshold or a limit at which a print quality deteriorates or a function of the printer 100 fails because a replaceable unit is used more than the corresponding replacement threshold information. Alternatively, the replacement threshold information may be set to a desired level at which the print quality is not yet affected such that the deterioration of the print quality may be prevented.

The first interface 170 interfaces the customer replaceable unit host device 200 and the printer 100.

The first controller 180 controls the overall operation of the printer 100 according to the first control program stored in the first non-volatile memory 140.

Additionally, the first controller 180 compares the replacement threshold information with the corresponding replaceable unit usage information stored in the CRUM 165 at the predetermined time intervals. If the usage of one or more certain replaceable units is greater than the corresponding replacement thresholds thereof, the replaceable unit usage information is transmitted to the customer replaceable unit host device 200 through the first interface 170 by the first controller 180.

The first controller 180 recognizes when the printer 100 is initially turned on, reads the replaceable unit usage information from the CRUM 165, and transmits the same information to the customer replaceable unit host device 200.

The replaceable unit usage information may be transmitted from the printer 100 (or from each printer 101, 102, 103, and 104 illustrated in FIG. 1) to the customer replaceable unit host device 200 when: (i) the user inputs the transmission command through the first input unit 110, (ii) at the predetermined time intervals set by the user through the first input unit 110, (iii) the replaceable unit usage information indicates that the usage of the one or more certain replaceable units is greater than the pre-stored corresponding replacement threshold, and (iv) the printer(s) 100 (or 101, 102, 103, and 104 illustrated in FIG. 1) is turned on. Additionally, it is possible to set or control the transmission to occur only if a predetermined number of these conditions are met.

The customer replaceable unit host device 200 includes a second input unit 210, a second display unit 220, a second volatile memory 230, a second non-volatile memory 240, a message generator 250, a replacement management unit 260, a second interface 270, and a second controller 280.

The second input unit 210 is used to input user commands. The second input unit 210 may include a keyboard, a mouse, etc. A user command signal input through the second input unit 210 is provided to the second controller 280. The second controller 280 then controls the customer replaceable unit host device 200, in response to the user command signal.

When a table display command is input through the second input unit 210, the second controller 280 controls the replacement management unit 260 to read the customer replaceable unit table from the second non-volatile memory 240. The second display unit 220 then displays the customer replaceable unit table.

The second display unit 220 displays all types of user notification messages, in response to the user command and/or under the control of the second controller 280.

As described above, the second display unit 220 displays the customer replaceable unit table, in response to the table display command input through the second input unit 210.

Additionally, if the second controller 280 searches for a target replacement (i.e., the certain one or more replaceable units that should be replaced), the second display unit 220 displays a replacement request notification information. The replacement request notification information may be a message requesting that a person of concern replace the certain one or more replaceable units of the printer 100 (or the printers 101, 102, 103, and 104 of FIG. 1) that are going to be exhausted in the near future, and includes information about the target replacement and the printer 100 (or the printers 101, 102, 103, and 104 illustrated in FIG. 1) that includes the target replacement.

The customer replaceable unit table and the replacement request notification information can be displayed through a web browser on the second display unit 220.

The second volatile memory 230 temporarily stores data that is produced during operation of the customer replaceable unit host device 200. Additionally, the second volatile memory 230 temporarily stores the replaceable unit usage information that is received by the customer replaceable unit host device 200 and transmitted through the second interface 270. Accordingly, the stored replaceable unit usage information is updated and recorded in the customer replaceable unit table by the replacement management unit 260.

The second non-volatile memory 240 stores a second control program to control overall operation of the customer replaceable unit host device 200. The second non-volatile memory 240 also stores the customer replaceable unit table.

The message generator 250 generates all types of messages according to the control of the second controller 280. An email may be used for these messages, however, it should be understood that the scope of the general inventive concept is not intended to be limited thereto. Other types of messages may also be used.

The message generator 250 generates a purchase order message based on the customer replaceable unit table. The generated purchase order message is then transmitted to the replacement sales server 300 (see FIG. 1) through the second interface 270 by the second controller 280. The purchase order message includes information about the target replacement and the printer 100 (or any of the printers 101, 102, 103, and 104 in FIG. 1) employing the target replacement.

In addition, the message generator 250 generates a replacement request message based on the customer replaceable unit table. The replacement request message is then transmitted to a replacement manager through the second interface unit 270. The replacement request message contains the information about the target replacement and the printer 100 (or any of the printers 101, 102, 103, and 104 in FIG. 1) employing the target replacement. Here, the replacement manager may be a customer replacement unit system manager, a device manager, or the like.

The replacement management unit 260 manages the customer replaceable unit table provided for each printer 100 (and/or the printers 101, 102, 103, and 104 in FIG. 1). More specifically, the replacement management unit 260 updates and records the replaceable unit usage information provided from each printer 100 (and/or the printers 101,102, 103, and 104 in FIG. 1) in the customer replaceable unit table for each printer 100 (and/or the printers 101, 102, 103, and 104 in FIG. 1). The replacement management unit 260 can be implemented as software that, for example, with a printer purchase.

Additionally, the replacement management unit 260 may generate usage statistical information by years, months, weeks, and/or designated time periods, based on the replaceable unit usage information provided from each printer 100 (and/or the printers 101,102, 103, and 104 in FIG. 1). The replacement management unit 260 may then record the usage statistical information in the customer replaceable unit table.

Based on the replaceable unit usage information from each printer 100 (and/or the printers 101, 102, 103, and 104 in FIG. 1), the replacement management unit 260 may also generate a replacement schedule for the replacement of each replaceable unit. The replacement management unit 260 may also record the replacement schedule in the customer replaceable unit table. The replacement schedule can be calculated based on the replaceable unit usage information and the predetermined time interval at which the replaceable unit usage information is collected.

The second interface 270 interfaces the printer 100 (and/or the printers 101, 102, 103, and 104 of FIG. 1) the customer replaceable unit host device 200.

The second controller 280 controls the overall operation of the customer replaceable unit host device 200 according to the second control program stored in the second non-volatile memory 240.

Additionally, the second controller 280 searches the customer replaceable unit table for a target replacement in each printer 100 (and/or the printers 101, 102, 103, and 104 in FIG. 1). If a target replacement exists, the second controller 280 generates a replacement request notification information. This replacement request notification information is then displayed on the second display unit 220 by the second controller 280. Particularly, the target replacement can be searched for by using the replaceable unit usage information, the usage statistical information, or the replacement schedule. However, the target replacement can be searched for and/or determined according to other additional information and/or criteria. The target replacement may include a plurality of target replacements.

As described above, the second controller 280 searches the customer replaceable unit table for a target replacement. If there is a target replacement to be replaced, the second controller 280 controls the message generator 250 to generate the purchase order message and to transmit the purchase order message to the replacement sales server 300 (see FIG. 1).

Similarly, if the target replacement is found in the customer replaceable unit table, the second controller 280 controls the message generator to generate the replacement request, message and to transmit the replacement request message to an address of the replacement manager. As described above, the replaceable units in the printer 100 and/or the printers 101, 102, 1 03, and 104 may include any replaceable part or expendable commodity usable in an image forming device.

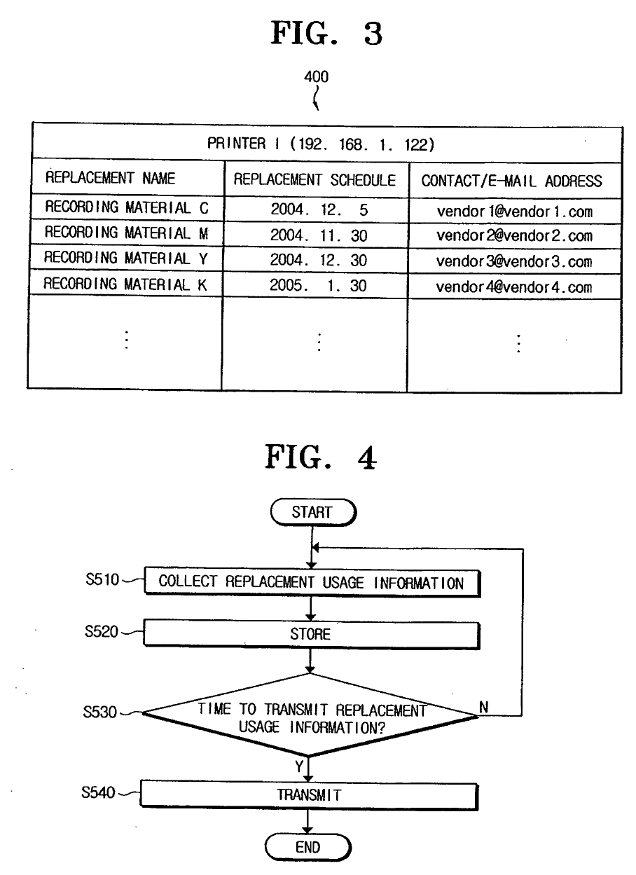

FIG. 3 illustrates a customer replaceable unit table 400 according to an embodiment of the present general inventive concept.

Referring to FIG. 3, the customer replaceable unit table 400 is prepared for each of one or more printers, and provides an IP address of each printer to identify the one or more printers.

Moreover, the customer replaceable unit table 400 provides names of replaceable units (replacements) installed in each printer, replacement schedules for the respective replaceable units, and information about current suppliers of each replaceable unit.

In FIG. 3, the customer replaceable unit table 400 illustrates C, M, Y and K recording materials as the replaceable units, the corresponding replacement schedules, and contact/e-mail addresses as the information about the suppliers of each replacement (e.g., vendor1@vendor1.com, vendor2@vendor21.com, vendor3@vendor3.com, vendor4@vendor4.com).

FIG. 4 is a flow chart illustrating a controlling method of a printer according to an embodiment of the present general inventive concept. The controlling method of FIG. 4 may be performed, for example, by the first controller 180 illustrated in FIG. 2. Accordingly, the controlling method of FIG. 4 is described below with reference to FIGS. 1 through 4.

Referring to FIGS. 1 to 4, the first controller 180 collects the replaceable unit (replacement) usage information at the predetermined time intervals (operation S510). The collected replacement usage information is stored in the CRUM 165 under the control of the first controller 180 (operation S520).

The first controller 180 determines whether it is time to transmit (i.e., whether it is a transmission time) the replaceable unit usage information to the customer replaceable unit host device 200 (operation S530).

If the transmission time has not yet arrived, the first controller 180 continues collecting (and/or monitoring) the replaceable unit usage information.

On the other hand, if the transmission time has arrived the replaceable unit usage information in the CRUM 165 is transmitted to the customer replaceable unit host device 200 through the first interface 170 by the first controller 180 (operation S540).

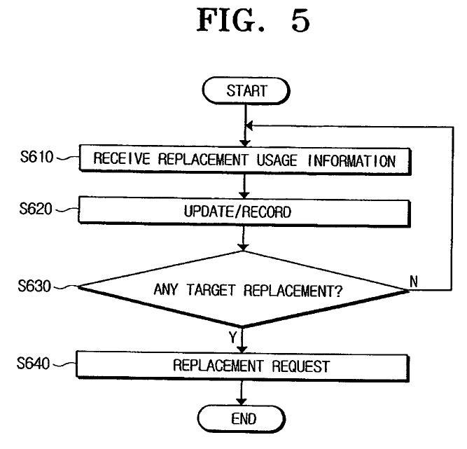

FIG. 5 is a flow chart illustrating a controlling method of a customer replaceable unit according to an embodiment of the present general inventive concept. The controlling method of FIG. 5 may be performed by, for example, the second controller 280 illustrated in FIG. 2. Accordingly, the controlling method of FIG. 5 is described below with reference to FIGS. 1 through 4.

Referring to FIGS. 1 to 5, when the customer replaceable unit host device 200 receives the replaceable unit (replacement) usage information from the printer 100 (operation S610), the replaceable unit usage information is updated and recorded in the customer replaceable unit table stored at a predetermined location of the second non-volatile memory 230 by the second controller 280 (operation S620).

The second controller 280 searches the customer replaceable unit table 400 for a target replacement installed in each printer 100 (and/or the printers 101, 102, 103, and 104 in FIG. 1) (operation S630).

If there is no target replacement (i.e., the certain one or more replaceable units that should be replaced) to be replaced, the customer replaceable unit host device 200 continues to receive the replaceable unit usage information from the printer 100 (and/or the printers 101, 102, 103, and 104 of FIG. 1) and updates the received replaceable unit usage information in the customer replaceable unit table, under the control of the second controller 280 (operations S610, S620).

If a target replacement to be replaced does exist, however, information about the target replacement and the corresponding printer 100 (and/or the printers 101, 102, 103, and 104 in FIG. 1) that employs the target replacement is used to provide a replacement request (operation S640).

The user and/or the replacement manager can be notified of the target replacement by controlling the second display unit 220 of the customer replaceable unit host device 200 to display a replacement request notification information.

Alternatively, the message generator 250 can generate the replacement request message and transmit the replacement request message to the address of the replacement manager.

Alternatively, the message generator 250 can generate the purchase order message and transmit the purchase order message to the replacement sales server 300 (see FIG. 1). The purchase order message and the replacement request message may be emails.

The embodiments of the present general inventive concept can be embodied in software, hardware, or a combination thereof. In particular, some embodiments can be computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, DVDs, etc.), and storage media such as carrier waves (e.g., transmission through the internet). The computer readable recording medium can also be distributed over network coupled computer systems so that the computer programs are stored and executed in a distributed fashion.

As described above, according to various embodiments of the present general inventive concept a customer replaceable unit host device and controlling methods thereof, can be used to collectively manage replaceable units in each image forming device in an effective manner. Accordingly, it is not necessary to manage the replaceable units in the image forming devices separately. Therefore, time required to manage the replaceable units in the image forming devices can be substantially reduced. Additionally, by managing a present status of the replaceable units of each image forming device in real time, it becomes possible to replace replaceable parts and/or expendable commodities at a proper time. This increases work efficiency and output of the image forming devices. Moreover, a customer replaceable table of the various embodiments of the general inventive concept facilitates a checking process of replaceable unit usages.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device in communication with a customer replaceable unit host device, comprising:
a recording material storage medium;
a customer replaceable unit memory (CRUM) associated with the recording material storage medium to store usage information for replaceable units installed in the image forming device; and
a first controller to collect the replaceable unit usage information, to control the replaceable unit usage information to be stored in the CRUM, and to transmit the stored replaceable unit usage information to the customer replaceable unit host device.

2. The device according to claim 1, further comprising:
an input unit to receive at least one of a transmission command to request an immediate transmission of the replaceable unit usage information from the CRUM to the customer replaceable unit host device and a set command to request a periodic transmission of the replaceable unit usage information from the CRUM to the customer replaceable unit host device at predetermined time intervals.

3. The device according to claim 1, wherein the CRUM further stores replacement threshold information of each replaceable unit, and the first controller compares the replacement threshold information with the corresponding replaceable unit usage information, and if the replaceable unit usage is greater than the corresponding replacement threshold the first controller controls the replaceable unit usage information to be transmitted to the customer replaceable unit host device.

4. The device according to claim 1, wherein, when the image forming device is initially turned on, the first controller controls the replaceable unit usage information in the CRUM to be transmitted to the customer replaceable unit host device.

5. A controlling method of an image forming device in communication with a customer replaceable unit host device, the method comprising:
collecting usage information of replaceable units installed in the image forming device;
storing the replaceable unit usage information in a customer replaceable unit memory (CRUM) associated with a recording material storage medium of the image forming device; and
transmitting the replaceable unit usage information in the CRUM to the customer replaceable unit host device.

6. The method according to claim 5, wherein the transmitting of the replaceable unit usage information in the CRUM to the customer replaceable unit host device comprises:
transmitting the replaceable unit usage information immediately to the customer replaceable unit host device if a transmission command requesting an immediate transmission of the replaceable unit usage information to the customer replaceable unit host device is input.

7. The method according to claim 5, wherein the transmitting of the replaceable unit usage information in the CRUM to the customer replaceable unit host device comprises:
transmitting the replaceable unit usage information to the customer replaceable unit host device at predetermined time intervals if a set command requesting a periodic transmission of the replaceable unit usage information to the customer replaceable unit host device at the predetermined time intervals is input.

8. The method according to claim 5, wherein the transmitting of the replaceable unit usage information in the CRUM to the customer replaceable unit host device comprises:
comparing replacement threshold information of each replaceable unit with the replaceable unit usage information stored in the CRUM; and
if a result of the comparison indicates that the replaceable unit usage is greater than the corresponding replacement threshold, transmitting the replaceable unit usage information to the customer replaceable unit host device.

9. The method according to claim 5, wherein the transmitting of the replaceable unit usage information in the CRUM to the customer replaceable unit host device comprises:
when the image forming device is initially turned on, transmitting the stored replaceable unit usage information to the customer replaceable unit host device.

10. A customer replaceable unit host device in communication with at least one image forming device, comprising:
a replacement management unit to provide a customer replaceable unit table based on usage information of replaceable units installed in the at least one image forming device, the replaceable unit usage information being obtained from a customer replaceable unit memory (CRUM) associated with a recording material storage medium of each of the at least one image forming device; and
a second controller to search the customer replaceable unit table for one or more target replacements associated with one or more of the replaceable units and to provide information about the one or more target replacements as a replacement request if the one or more target replacements exist.

11. The device according to claim 10, wherein the customer replaceable unit table provides at least one of replacement name(s), replacement schedules prepared based on the replaceable unit usage information, and information about suppliers of the respective replaceable units.

12. The device according to claim 10, further comprising:
a second input unit to receive a display command to display the customer replaceable unit table; and
a second display unit to display the customer replaceable unit table under the control of the second controller, in response to the received display command.

13. The device according to claim 10, further comprising:
a display unit to display a replacement request notification information containing information about the one or more target replacements that is generated based on the customer replaceable unit table.

14. The device according to claim 10, further comprising:
a message generator to generate at least one of a purchase order message containing information about the one or more target replacements being provided to a replacement sales server according to the customer replaceable unit table and a replacement request message containing information about the one or more target replacements being provided to a replacement manager according to the customer replaceable unit table.

15. The device according to claim 10, wherein the replacement management unit generates usage statistical information for predetermined periods based on the replaceable unit usage information and records the usage statistical information in the customer replaceable unit table.

16. A controlling method of a customer replaceable unit host device in communication with at least one image forming device, the method comprising:
receiving usage information about replaceable units installed in the at least one image forming device from a customer replaceable unit memory (CRUM) associated with a recording material storage medium of each of the at least one image forming device;
preparing a customer replaceable unit table based on the received replaceable unit usage information;
searching the customer replaceable unit table for one or more target replacements associated with one or more of the replaceable units; and
if the one or more target replacements exist, providing information about the one or more target replacements as a replacement request.

17. The method according to claim 17, wherein the providing of the information about the one or more target replacements comprises:
displaying a replacement request notification information containing the information about the one or more target replacements.

18. The method according to claim 16, wherein the providing of the information about the one or more target replacement comprises:
generating a purchase order message containing the information about the one or more target replacements based on the customer replaceable unit table; and
transmitting the purchase order message to a replacement sales server.

19. The method according to claim 16, wherein the providing of the information about the one or more target replacements comprises:
generating a replacement request message containing the information about the one or more target replacements based on the customer replaceable unit table; and
transmitting the replacement request message to a replacement manager.

20. The method according to claim 16, further comprising:
generating usage statistical information for predetermined periods based on the replaceable unit usage information; and
recording the usage statistical information in the customer replaceable unit table.
